(19) United States
(12) Patent Application Publication
(10) Pub. No.: US 2026/0300430 A1
(43) Pub. Date: Oct. 1, 2026

(54) SOLVING SYSTEM, TRAINING METHOD AND SOLVING METHOD FOR PARTIAL DIFFERENTIAL EQUATIONS OF ELECTRIC FIELD OF INTEGRATED CIRCUIT DEVICE

(71) Applicant: HUAZHONG UNIVERSITY OF SCIENCE AND TECHNOLOGY, Hubei (CN)

(72) Inventors: Xingsheng Wang, Hubei (CN); Pinfeng Jiang, Hubei (CN); Letian Wang, Hubei (CN); Zhiliang Peng, Hubei (CN); Yilong Fang, Hubei (CN); Yi Wang, Hubei (CN); Xiangshui MIAO, Hubei (CN)

(73) Assignee: HUAZHONG UNIVERSITY OF SCIENCE AND TECHNOLOGY, Hubei (CN)

(21) Appl. No.: 19/538,928

(22) Filed: Feb. 12, 2026

(30) Foreign Application Priority Data
Mar. 26, 2025 (CN) 202510360868.0

(51) Int. Cl. G06F 17/16; G06F 30/367; G06N 3/084; G06V 10/82

(52) U.S. Cl. CPC G06F 17/16; G06F 30/367; G06N 3/084; G06V 10/82

(57) ABSTRACT

A solving system, a training method, and a solving method for partial differential equations of an electric field of an integrated circuit device belong to the technical field of integrated circuits. After global features of a geometric parameter, an electrical parameter, and a material property of the integrated circuit device are extracted, a geometry-electricity-material tri-coupling mechanism is constructed through a fusion module, so as to fuse the global features of the geometric parameter, the electrical parameter, and the physical property. First, a physical field consistency mapping mechanism is introduced to map an electrical feature to a high-dimensional feature space aligned with a geometric feature, and a coupling capability between the electrical feature and the geometric feature is enhanced. Through an attention mechanism, the degree of mutual influence among the geometric parameter, the electrical parameter, and the material property in each of the different electric field regions are then dynamically evaluated.

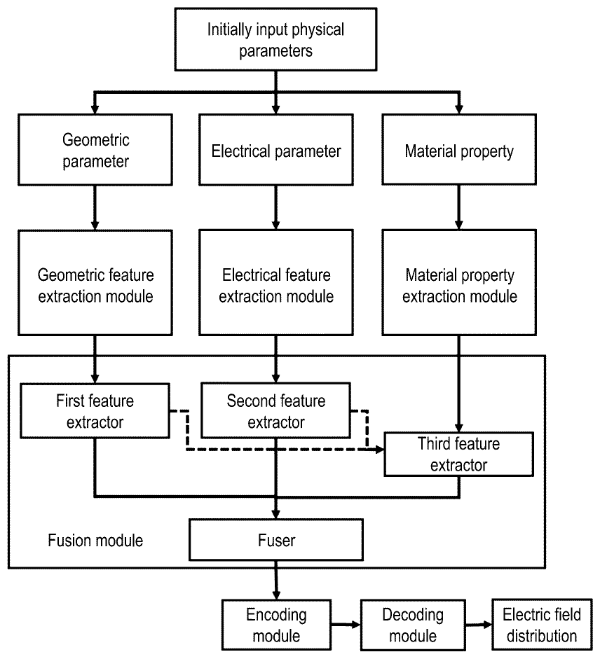

### CROSS-REFERENCE TO RELATED APPLICATION

This application claims the priority benefit of China application serial no. 202510360868.0, filed on Mar. 26, 2025. The entirety of the above-mentioned patent application is hereby incorporated by reference herein and made a part of this specification.

### BACKGROUND

### Technical Field

The disclosure belongs to the technical field of integrated circuits, and more specifically, relates to a solving system, a training method, and a solving method for partial differential equations of an electric field of an integrated circuit device.

### Description of Related Art

With the development of integrated circuit technology, integrated circuit devices have been widely applied in high-performance and low-power chip design. In modern chip design, the device structures are becoming increasingly complex and the geometric sizes are continuously decreasing, which makes the electric field distribution inside an integrated circuit device more nonlinear and has multi-scale characteristics. In order to achieve accurate simulation and optimization of electrical performance of integrated circuit devices, precise modeling and efficient solving of the electric field distribution are necessary, which relies on partial differential equations (PDEs) as the fundamental mathematical description.

In conventional methods for solving partial differential equations, such as the finite difference method and the finite element method, high-density grid discretization is required to be performed most of the time for complex geometric shapes and boundary conditions of the integrated circuit devices, so these methods rely on a large number of iterative calculations to complete the solving. This high computational complexity significantly affects the speed and efficiency of iteration design, especially when facing multi-dimensional and multi-scale electric field modeling of integrated circuit devices, obviously deficiencies arise.

In recent years, the machine learning technology has been gradually applied to solving partial differential equations, especially showing favorable prospects in accelerating computation. For instance, in an existing method for solving partial differential equations based on the machine learning technology, the mapping relationship between the computational domain and the boundary conditions of the partial differential equations and the solving results is learned by training the machine learning models. However, this method is only applicable to solving simple partial differential equations. The structure of integrated circuit devices focused on by the disclosure has nonlinear boundary conditions, and the structure of electric field partial differential equations is relatively complex, so the solving accuracy of the existing method is unfavorable.

### SUMMARY

In view of the above defects or improvement needs of the relate art, the disclosure provides a solving system, a training method, and a solving method for partial differential equations of an electric field of an integrated circuit device, so as to solve the technical problem found in the related art that the partial differential equations of the electric field of the integrated circuit device cannot be accurately solved.

In order to achieve the above objective, in the first aspect, the disclosure provides a solving system for partial differential equations of an electric field of an integrated circuit device including the following modules.

A geometric feature extraction module is configured to extract a feature of a geometric parameter of the integrated circuit device to obtain a first global geometric feature. An electrical feature extraction module is configured to extract a feature of an electrical parameter of the integrated circuit device to obtain a first global electrical feature. Further, a material feature extraction module is configured to extract a feature of a material property of the integrated circuit device to obtain a first global material feature.

A fusion module is configured to fuse the first global geometric feature, the first global electrical feature, and the first global material feature to obtain a fused feature.

An encoding module is configured to encode the fused feature to obtain an encoded feature.

A decoding module is configured to decode the encoded feature to obtain electric field distribution of the integrated circuit device.

The fusion module includes the following.

A first feature extractor is configured to perform spatial grid division on the first global geometric feature according to an integrated circuit device structure to obtain a local geometric feature of each grid unit, perform feature extraction on each local geometric feature to obtain a geometric parameter feature of each grid unit, and perform embedding processing on the geometric parameter feature of each grid unit to obtain a geometric embedding feature of each grid unit, which together constitute a second global geometric feature.

A second feature extractor is configured to perform feature extraction on the first global electrical feature at multiple scales and perform embedding processing on an obtained feature of each scale to obtain an electrical embedding feature corresponding to each scale, which together constitute a second global electrical feature.

A third feature extractor includes a fully-connected layer and is configured to input a feature obtained by adding the second global geometric feature and the second global electrical feature into the fully-connected layer for feature extraction and add an extracted feature to the first global material feature to obtain a second global material feature.

A fuser is configured to treat the second global geometric feature, the second global electrical feature, and the second global material feature as a query matrix, a key matrix, and a value matrix respectively, and performs fusion based on an attention mechanism to obtain a fused feature.

Further preferably, the encoding module includes an embedding layer and an encoder.

The embedding layer is configured to perform embedding processing on the fused feature to obtain a fused embedding feature.

The encoder includes m cascaded attention modules configured to process the fused embedding feature based on the attention mechanism to obtain an encoded feature, and m≥2.

Further preferably, the process of processing an input feature performed by each attention module of the first m₁ attention modules in the encoder based on the attention mechanism further includes the following. Static pruning is performed on an attention map matrix after obtaining the attention map matrix, and m₁≥1.

In a training stage of the solving system, the attention module performs static pruning on the attention map matrix by the following manners. The attention map matrix is copied to obtain a corresponding copy matrix. Columns in the copy matrix are summed after elements in the copy matrix that are less than a first predetermined threshold are set to 0. The columns of the copy matrix are sorted in a descending order according to a column summation result. Non-zero elements in the copy matrix are set to 1 to obtain a mask matrix. The obtained mask matrix is saved, and a mapping relationship between an original column number and a sorted column number of each column is recorded in the copy matrix. Columns of the attention map matrix are sorted based on the mapping relationship, and dot multiplication with the mask matrix is then performed to complete the static pruning on the attention map matrix

In a solving stage, the attention module performs static pruning on the attention map matrix by the following manners. After the columns of the attention map matrix are sorted based on the corresponding mapping relationship obtained in the training stage, the dot multiplication with the corresponding mask matrix obtained in the training stage is performed to complete the static pruning on the attention map matrix.

Further preferably, the process of processing the input feature by each attention module of the last m-m₁ attention modules in the encoder based on the attention mechanism further includes the following. Dynamic pruning is performed on the attention map matrix after the attention map matrix is obtained.

After elements in the attention map matrix that are less than a second predetermined threshold are set to 0, the columns of the attention map matrix are sorted in a descending order according to the column summation result to complete the dynamic pruning on the attention map matrix.

Further preferably, the above decoding module includes a cascaded feedforward neural network and a decoder, and the feedforward neural network includes a plurality of cascaded fully-connected layers.

An activation function of the fully-connected layers is a ReLU function.

In the solving stage, a first fully-connected layer L in the feedforward neural network is a fully-connected layer with all inactivated neurons removed.

The inactivated neurons are neurons whose outputs are always 0 in the fully-connected layer L counted during the training stage of the solving system.

Further preferably, the decoder is a KAN model.

In the second aspect, the disclosure further provides a training method for the above solving system, and the training method includes the following steps.

Training samples in a training set are treated as input, corresponding electric field distribution labels are treated as output, and the solving system is trained.

The training set is obtained through the following manner.

Real electric field distributions of different integrated circuit devices under different physical parameters are collected. The physical parameters include a geometric parameter, an electrical parameter, and a material property.

The training set with the physical parameters as the training samples and the corresponding real electric field distributions as the electric field distribution labels is constructed.

In the third aspect, the disclosure further provides a solving method for partial differential equations of an electric field of an integrated circuit device, and the method includes the following steps.

Physical parameters of the integrated circuit device to be solved are input into the solving system provided in the first aspect of the disclosure, to obtain the electric field distribution of the integrated circuit device.

The physical parameters include a geometric parameter, an electrical parameter, and a material property.

In the fourth aspect, the disclosure further provides an electronic device including a memory and a processor. The memory stores a computer program, and the processor, when executing the computer program, executes the training method for the solving system provided in the second aspect of the disclosure or the solving method provided in the third aspect.

In the fifth aspect, the disclosure further provides a computer-readable storage medium. The computer-readable storage medium includes a stored computer program. When the computer program is run by a processor, an apparatus where the storage medium is located is controlled to execute the training method for the solving system provided in the second aspect of the disclosure or the solving method provided in the third aspect.

In the sixth aspect, the disclosure further provides a computer program product including a computer program/instruction. When the computer program/instruction is executed by a processor, the training method for the solving system provided in the second aspect or the solving method provided in the third aspect is implemented.

In general, through the above technical solutions conceived by the disclosure, the following beneficial effects may be achieved.
1. The disclosure provides the solving system for the partial differential equations of the electric field of the integrated circuit device. Global features of the geometric parameter, the electrical parameter, and the material property of the integrated circuit device are extracted through different feature extraction modules. Each feature extraction module focuses on extracting one type of physical parameter to ensure that the feature extraction processes of different input parameters are independent from each other and accurate. On this basis, a geometry-electrical-material tri-coupling mechanism is constructed through the fusion module to fuse the global features of the geometric parameter, the electrical parameter, and the physical property. First, a physical field consistency mapping mechanism is introduced to map the electrical feature to a high-dimensional feature space aligned with the geometric feature. In this way, the spatial consistency and complementarity in expression between the two is ensured, and the coupling capability between electrical feature and geometric feature is enhanced. Next, through the attention mechanism, the degree of mutual influence of the geometric parameter, the electrical parameter, and the material property in different electric field regions is dynamically evaluated, and the deep coupling of the three features is dynamically achieved, which solves the expression problem of nonlinear complex regions in the electric field solving of the integrated circuit devices. In this way, the extracted feature information is better aggregated, and the accuracy of solving the partial differential equations of the electric field of the integrated circuit device is improved.
2. Further, in the solving system for the partial differential equations of the electric field of the integrated circuit device provided by the disclosure, the encoding module includes the embedding layer and the encoder. The embedding layer can dynamically aggregate input feature information and add position information to the input data, so that features in different input structures are better expressed. The encoder includes a plurality of cascaded attention modules, which may focus on capturing the dependency relationship between the geometric parameter and the boundary condition of the integrated circuit device, representing complex physical characteristics in the electric field of the integrated circuit, and highly-structured feature expression for downstream tasks is provided. In this way, the solving system can more closely conform to the mathematical structure in operator learning while efficiently learning operator mapping, and the accuracy of solving the partial differential equations of the electric field is further improved.
3. Further, in the solving system for the partial differential equations of the electric field of integrated circuit device provided by the disclosure, the process of processing input features based on the attention mechanism performed by each attention module of the first m₁ attention modules in the encoder further includes the following. After the attention map matrix is obtained, static pruning is performed on the attention map matrix. By dynamically selecting and focusing on the most representative features in the input data, global information is thereby effectively aggregated. In this way, the computational load is significantly reduced, facilitating the computing device to balance the workload, and the entire computational process is thus accelerated.
4. Further, in the solving system for the partial differential equations of the electric field of the integrated circuit device provided by the disclosure, the process of processing the input features based on the attention mechanism performed by each attention module of the last m-m₁ attention modules in the encoder further includes the following. After the attention map matrix is obtained, dynamic pruning is performed on the attention map matrix, to effectively retain the key feature information of the input data. The accuracy of the solving result is thus not affected.
5. Further, in the solving system for the partial differential equations of the electric field of the integrated circuit device provided by the disclosure, the decoding module includes the cascaded feedforward neural network and the decoder. The feedforward neural network includes a plurality of cascaded fully-connected layers and is configured to capture feature changes at different scales in the electric field of the integrated circuit device, including the relationship between the local electric field gradient and the global potential distribution. The activation function of the fully-connected layers is a ReLU function. In the solving phase, the first fully-connected layer L in the feedforward neural network is a fully-connected layer after removing all inactivated neurons. Since the solution of partial differential equations of the integrated circuit device has significant sparsity and diversity and the activation function of the fully-connected layers is a ReLU function, there are a large number of inactivated neurons in the output of the first fully-connected layer. Cascaded neuron pruning is introduced in the decoding module, by marking inactivated neurons during the training process and skipping the related computation of these neurons during the solving process. The computational load of forward propagation is thus significantly reduced, which not only accelerates the decoding process, but also effectively reduces the demand for computational resources, enabling the decoding module to quickly and accurately generate solving results consistent with the electric field characteristics of integrated circuit device. The efficiency and applicability of the entire partial differential equation solving are thus significantly improved.
6. Further, in the solving system for the partial differential equations of the electric field of the integrated circuit device provided by the disclosure, the decoder is a KAN model. The KAN model, through its high nonlinear representation capability, can effectively capture the influence of sharp potential gradients, strongly coupled regions, or complex structures on the solution characteristics in the electric field of the integrated circuit device. The decoding module can dynamically adjust the network structure and the parameters of the KAN to more precisely match the specific physical characteristics of the electric field of integrated circuit device. Through this flexible adjustment, the decoding module can not only improve the fitting accuracy for complex solutions, but also optimize the processing effect for discontinuous or non-smooth solutions. Through efficient feature processing and precise function matching, the decoding module significantly improves the efficiency and result accuracy of solving the partial differential equations of the electric field of the integrated circuit device.

### BRIEF DESCRIPTION OF THE DRAWINGS

FIGURE is a structural schematic diagram of a solving system for partial differential equations of an electric field of an integrated circuit device provided by an embodiment of the disclosure.

### DESCRIPTION OF THE EMBODIMENTS

In order to make the objectives, technical solutions, and advantages of the disclosure more clear, the disclosure is further described in detail below in conjunction with the accompanying drawings and embodiments. It should be understood that the specific embodiments described herein are only used to explain the disclosure and are not intended to limit the disclosure. In addition, the technical features involved in the various embodiments of the disclosure described below may be combined with each other as long as they do not conflict with each other.

In order to achieve the above objectives, in the first aspect, the disclosure provides a solving system for partial differential equations of an electric field of an integrated circuit device, as shown in FIGURE, including the following modules.

A geometric feature extraction module is configured to extract a feature of a geometric parameter of the integrated circuit device to obtain a first global geometric feature. An electrical feature extraction module is configured to extract a feature of an electrical parameter of the integrated circuit device to obtain a first global electrical feature. A material feature extraction module is configured to extract a feature of a material property of the integrated circuit device to obtain a first global material feature.

A fusion module is configured to fuse the first global geometric feature, the first global electrical feature, and the first global material feature to obtain a fused feature.

An encoding module is configured to encode the fused feature to obtain an encoded feature.

A decoding module is configured to decode the encoded feature to obtain electric field distribution of the integrated circuit device.

It should be noted that input parameters of the partial differential equations of the above integrated circuit device include the geometric parameter (e.g., gate pitch, etc.), the electrical parameter (e.g., gate voltage, source-drain voltage, etc.), the material property (e.g., dielectric constant, doping concentration distribution, etc.), and grid information. These parameters may be represented as one-dimensional parameter vectors, two-dimensional grids, or high-dimensional tensors to meet the modeling needs of complex multi-scale characteristics of the integrated circuit device. The above integrated circuit device may be FinFET, FD-SOI, planar CMOS, and other devices, which is not limited herein. Taking the FinFET as an example, the above geometric parameter includes fin width, fin height, gate pitch, and other parameters. The electrical parameter includes gate voltage, source-drain voltage, and other parameters. The material property includes dielectric constant, doping concentration distribution, and other parameters.

The above partial differential equations are specifically used to describe the electric field distribution characteristics of the integrated circuit device, including a three-dimensional Poisson equation, a three-dimensional Laplace equation, etc., which is not limited herein. These equations are used to accurately model the electric field distribution within the integrated circuit device, specifically including: potential distribution, capacitive coupling effect, carrier concentration gradient, and other information, which may reflect the influence of complex geometric structures, electrical parameters, and non-uniform material properties on the electric field.

It should be noted that the above geometric feature extraction module, the electrical feature extraction module, and the material feature extraction module may be neural network models such as a fully-connected neural network, a multi-layer perceptron (MLP), a convolutional neural network (CNN), a residual neural network (ResNet), etc., which is not limited herein. Preferably, in an optional embodiment, each of the above feature extraction modules adopts a convolutional neural network containing two convolutional layers, where the convolutional kernels of the convolutional layers are sparsely optimized to achieve adaptive length and weight. This design enables the feature extraction units to dynamically adjust the size, the stride, and the padding of each convolutional kernel according to the local features of the input data, so key information in the input function can be more effectively captured. Through this adaptive mechanism, the solving system may flexibly cope with the feature extraction needs of different types of input parameters, so that the accuracy and efficiency of feature extraction are improved, redundant computation is reduced, and the performance of the overall solving system is thus enhanced.

It should be noted that the fusion module combines information of different physical parameters (including the geometric parameter, the electrical parameter, and the material property), and constructs a deep coupling model among the geometric structure parameter, the electrical parameter, and the material property through a geometry-electrical-material tri-coupling mechanism, and key features of the electric field are thus ensured to be accurately captured.

Specifically, the fusion module includes the following.

A first feature extractor is configured to perform spatial grid division on the first global geometric feature according to an integrated circuit device structure to obtain a local geometric feature of each grid unit, performs feature extraction on each local geometric feature to obtain a geometric parameter feature of each grid unit, and performs embedding processing on the geometric parameter feature of each grid unit to obtain a geometric embedding feature of each grid unit, which together constitute a second global geometric feature.

A second feature extractor is configured to perform feature extraction on the first global electrical feature at multiple scales and performs embedding processing on an obtained feature of each scale to obtain an electrical embedding feature corresponding to each scale, which together constitute a second global electrical feature.

A third feature extractor includes a fully-connected layer and is configured to input a feature obtained by adding the second global geometric feature and the second global electrical feature into the fully-connected layer for feature extraction and add an extracted feature to the first global material feature to obtain a second global material feature.

A fuser is configured to treat the second global geometric feature, the second global electrical feature, and the second global material feature as a query matrix, a key matrix, and a value matrix respectively, and performs fusion based on an attention mechanism to obtain a fused feature.

Each of the above-mentioned first feature extractor and the second feature extractor may be a neural network model such as a fully-connected neural network, a multilayer perceptron (MLP), a convolutional neural network (CNN), a residual neural network (ResNet), etc., which are not limited herein.

The fusion module provided by the disclosure solves the expression problem of nonlinear complex regions in electric field solving of the integrated circuit device by constructing a geometry-electricity-material tri-coupling mechanism, to better aggregate the extracted feature information. In a specific embodiment, the input first global geometric feature performs spatial grid division on the device structure through the first feature extractor, so as to extract the local geometric feature of each grid unit. Subsequently, feature extraction is further performed on these local geometric features, so as to obtain the corresponding geometric parameter feature. The geometric parameter feature of each grid unit is encoded into a high-dimensional feature vector corresponding to each grid unit through an embedding layer, and spatial geometric feature representation that may be processed by the fusion module is thereby formed. During the embedding process, a boundary constraint module is added, including: dynamically marking key regional features such as sharp corners, surface inflection points, and thin-layer structures. Different weights are assigned to different key regional features, so that geometric spatial priority weights are provided for the subsequent coupling process. The first global electrical feature extracts an electric field response features of various regions of the device at multi-resolution scales through a dynamic weighted convolutional network. To enhance the coupling capability between the electrical feature and the geometric feature, a physical field consistency mapping mechanism is introduced, which maps the electrical feature to a high-dimensional feature space aligned with the geometric feature, so that spatial consistency and representational complementarity between the two are ensured. The material property adopts a regional adaptive decomposition mechanism, which dynamically assigns different weights to material features for different geometric and electrical feature regions. For instance, in a high dielectric constant region, priority is given to an electric potential distribution feature, while in regions with drastic conductivity changes, priority is given to focusing on carrier concentration changes. After the preliminary alignment of the geometric feature, the electrical feature, and the material feature is completed, a geometry-electricity-material joint attention mechanism is adopted to dynamically achieve deep coupling of the three. First, through the attention mechanism, the mutual influence degree of the geometric structure parameters, the electrical parameters, and the material properties in different electric field regions is dynamically evaluated. Especially for a complex boundary condition and a non-uniform region, the focus is on capturing the nonlinear modulation effect of material property changes on electric field distribution and carrier concentration. Finally, a high-dimensional coupled feature vector is output to accurately express the electric field distribution in complex regions under multi-physics fields.

It should be noted that the encoding module is configured to encode the fused feature information, focuses on capturing a dependency relationship between the geometric parameter and the boundary condition of the integrated circuit device, represents complex physical characteristics in the electric field of the integrated circuit, and provides highly-structured feature expression for a downstream task. The encoding module may be an attention mechanism, a convolutional neural network, a residual neural network, etc., which is not limited herein. Preferably, in an optional embodiment, the encoding module includes an embedding layer and an encoder.

The embedding layer is configured to perform embedding processing on the fused features to obtain a fused embedded feature.

The encoder includes m cascaded attention modules configured to process the fused embedded feature based on the attention mechanism to obtain an encoded feature, and m≥2.

Through the above design, the encoding module is able to dynamically aggregate the input feature information and add position information to the input data, so that features in different input structures are better expressed. In addition, the encoding module also enables the solving system to more closely conform to the mathematical structure in operator learning while efficiently learning operator mapping.

In an optional embodiment, the process of processing an input feature performed by each attention module of the first m₁ attention modules in the encoder based on the attention mechanism further includes the following. Static pruning is performed on an attention map matrix after the attention map matrix is obtained, and m₁≥1.

Herein, in the training stage of the solving system, the attention module performs static pruning on the attention map matrix in the following manners. The attention map matrix is copied to obtain a corresponding copy matrix. Columns in the copy matrix are summed after elements in the copy matrix that are less than a first predetermined threshold are set to 0, the columns of the copy matrix are sorted in a descending order according to a column summation result, and non-zero elements in the copy matrix are set to 1 to obtain a mask matrix. The obtained mask matrix is saved, and a mapping relationship between an original column number and a sorted column number of each column in the copy matrix is recorded. Columns of the attention map matrix are sorted based on the mapping relationship, and dot multiplication with the mask matrix is then performed to complete the static pruning on the attention map matrix.

In a solving stage, the attention module performs static pruning on the attention map matrix by the following manner. The columns of the attention map matrix are sorted based on the corresponding mapping relationship obtained in the training stage, and dot multiplication with the corresponding mask matrix obtained in the training stage is then performed to complete the static pruning on the attention map matrix.

Through the above design, the encoding module introduces a hybrid sparse attention mechanism, dynamically selects and focuses on the most representative feature in the input data, and thereby effectively aggregates global information. During the training process, the encoding module completes efficient pruning sparse processing according to numerical values of the attention map, obtains a copy matrix of the attention map matrix, clears the numerical value positions that are less than the set threshold, and marks their corresponding position labels. Next, the copy matrix is sorted in the column direction according to the cumulative numerical values by columns, and the corresponding relationship (mapping relationship) between the original column numbers and the sorted column numbers is recorded. The non-zero elements in the reordered copy matrix are set to 1 to obtain a binary mask matrix. In the inference process of solving the partial differential equation, each column of the attention map matrix is sorted based on the corresponding mapping relationship obtained in the training stage, and then dot multiplication is performed with the corresponding mask matrix obtained in the training stage to complete the static pruning on the attention map matrix, and static pruning sparse processing on the attention map is thus achieved. In this way, the computational load is significantly reduced, facilitating the computing device to balance the workload, and the entire computational process is thus accelerated.

In order to ensure the solving accuracy of the partial differential equation, the acceleration method dynamically selects the attention map matrices in the attention module that need to undergo static pruning sparsification, while the remaining attention map matrices in the attention module adopt a dynamic pruning sparsification scheme.

Further, in an optional embodiment, the process of processing the input feature by each attention module of the last m-m₁ attention modules in the encoder based on the attention mechanism further includes the following. Dynamic pruning is performed on the attention map matrix after the attention map matrix is obtained

After elements in the attention map matrix that are less than a second predetermined threshold are set to 0, the columns of the attention map matrix are sorted in a descending order according to the column summation result to complete the dynamic pruning on the attention map matrix. Next, the reordered attention map matrix is output to the next layer. This scheme effectively preserves the key feature information of the input data without affecting the accuracy of the solving results.

It should be noted that the task of the decoding module is to map the encoded feature output by the encoding module to a required target output space. That is, mapping the high-dimensional feature output by the encoding module to a target solving result, including key electric field distribution physical quantities such as potential distribution, carrier concentration, and capacitive coupling effects. The decoding module may be a multi-layer perceptron, an attention mechanism module, a convolutional neural network, a residual neural network, etc., which is not limited herein. Preferably, in an optional embodiment, the above decoding module includes a cascaded feedforward neural network and a decoder. The feedforward neural network includes a plurality of cascaded fully-connected layers, preferably two cascaded fully-connected layers. An activation function of the fully-connected layers is a ReLU function. In the solving stage, a first fully-connected layer L in the feedforward neural network is a fully-connected layer with all inactivated neurons removed. The inactivated neurons are neurons whose outputs are always 0 in the fully-connected layer L counted during the training stage of the solving system.

The feedforward neural network is capable of capturing feature changes at different scales in the electric field of the integrated circuit device, including the relationship between local electric field gradients and global potential distribution. Since the solution of the partial differential equations for the integrated circuit device has significant sparsity and diversity and the activation function of the fully-connected layers is a ReLU function, there are a large number of inactivated neurons in the output of the first fully-connected layer. Cascaded neuron pruning is introduced in the decoding module, which marks inactivated neurons during the training process and skips the related computation of these neurons during the solving process (inference process), so the computational load of forward propagation is significantly reduced. Specifically, during training, the labels of inactivated neurons are determined according to the output of the first layer. During inference, redundant computation of the first layer and subsequent layers are skipped according to these labels, so that the mapping process from features to target physical quantities is ensured to be more efficient. In this optimized design, the decoding process is accelerated, and the demand for computational resources is effectively reduced, enabling the decoding module to quickly and accurately generate solving results that conform to the electric field characteristics of the integrated circuit device. Therefore, the efficiency and applicability of the entire partial differential equation solving are significantly improved.

It should be noted that the above decoder may be a KAN model, a convolutional neural network, an attention mechanism module, a residual neural network, etc., which is not limited herein. Preferably, the above decoder is a KAN model. The decoding module is capable of flexibly activating the KAN model according to the complexity of the solutions of the partial differential equations for the electric field of the integrated circuit device, so as to adapt to the solution characteristics under non-smooth solutions or complex geometric boundaries commonly found in integrated circuit devices. Through its high nonlinear representation capability, the KAN model is capable of more precisely matching the complex solution characteristics related to the electric field of the integrated circuit device, such as sharp field strength gradients or discontinuous solutions under gate voltage variations, and is capable of effectively capturing the effects of sharp potential gradients, strongly coupled regions, or complex structures on solution characteristics in electric fields of integrated circuit devices. The decoding module may dynamically adjust the network structure and parameters of the KAN to more precisely match the specific physical characteristics of the electric field of the integrated circuit device, such as non-uniform electric field distribution under gate voltage and local transition of carrier density. Through such flexible adjustment, the decoding module is capable of not only improving the fitting accuracy for complex solutions, but also optimizing the processing effect for discontinuous or non-smooth solutions. Through efficient feature processing and precise function matching, the decoding module significantly improves the efficiency and result accuracy of solving the partial differential equations for the electric field of the integrated circuit device. In this design, the needs of integrated circuit device modeling and performance optimization are effectively supported, and important application values are demonstrated in high-precision simulation and high-performance design.

Based on the above design, the decoding module is capable of adapting to different smoothness levels of electric field solutions of integrated circuit devices, effectively matching the effects of sharp gradients in non-uniform electric fields or complex geometric boundaries on solution characteristics through dynamically adjusting the network structures, so that the accuracy and stability of output results are ensured.

In the second aspect, the disclosure provides a training method for the above solving system, and the method includes the following steps.

Training samples in a training set are treated as input and corresponding electric field distribution labels are treated as output to train the solving system provided in the first aspect of the disclosure. The related technical solutions are the same as the solving system provided in the first aspect of the disclosure, and description thereof is thus not repeated herein.

The training set is obtained through the following manners.

Real electric field distributions of different integrated circuit devices under different physical parameters are collected. The physical parameters include a geometric parameter, an electrical parameter, and a material property.

The training set is constructed with the physical parameters as the training samples and the corresponding real electric field distributions as the electric field distribution labels.

It should be noted that there are multiple methods for collecting real electric field distributions of different integrated circuit devices under different physical parameters. In an optional embodiment, the real electric field distributions may be obtained through direct measurement. In another optional embodiment, the finite difference method is used to solve for different physical parameters, so as to obtain corresponding high-precision result data such as potential distribution, carrier concentration, and capacitance coupling effects, which constitute the corresponding real electric field distributions.

In an optional embodiment, after the training is completed, according to the input parameter formats of different partial differential equations, a set of representative random data is generated as a test data set and is input into the trained solving system to obtain corresponding electric field distributions as a data set to be evaluated.

The finite difference method is used to solve the input parameters of the test data set to obtain corresponding real electric field distributions as a verification data set.

An error between the data set to be evaluated and the verification data set is calculated. When the error exceeds a predetermined error threshold, the parameters in the solving system are readjusted, and training is performed again. When the error does not exceed the predetermined error threshold, the training is ended.

By verifying the performance of the solving system, and continuing to return to training when the prediction does not meet the requirements, the accuracy of the solution system may be further improved.

In order to further illustrate the solving system and the training method for the partial differential equations of the electric field of the integrated circuit device provided by the disclosure, a detailed description is provided in the following paragraphs with a specific embodiment.

This embodiment provides a method for constructing a solving system for a three-dimensional Poisson equation of electric field distribution in an integrated circuit device, and the method includes the following steps.

In A1, a geometric parameter, an electrical parameter, and a material property of the integrated circuit device are acquired. A device region is divided into a three-dimensional problem domain, and non-uniform grids are used for random sampling. The above Poisson equation is numerically solved through the finite difference method to obtain accurate electric potential distribution data, and a training sample set is constructed.

In A2, a feature extraction module of the solving system is constructed. 3 feature extraction units, including a geometric feature extraction module, an electrical feature extraction module, and a material feature extraction module, are designed, and each feature extraction unit is configured to extract a corresponding type of an input function feature. The geometric feature extraction module is configured to process a one-dimensional parameter vector of the geometric parameter, extract a feature of the geometric parameter, and obtain a first global geometric feature. The electrical feature extraction module is configured to extract a feature of the electrical parameter of the integrated circuit device (such as extracting a three-dimensional boundary condition of boundary potential) and obtain a first global electrical feature. The material feature extraction module is configured to extract a feature of the material property and obtain a first global material feature.

In this embodiment, each of the above feature extraction units is a convolutional neural network including two convolutional layers, and each convolutional layer includes 9 convolutional kernels. The convolutional neural network dynamically adjusts the size, stride, and padding of different convolutional kernels according to a local feature of input data, so as to accurately capture a local feature of electric field distribution of the integrated circuit device.

In A3: a fusion module of the solving system configured to combine information from different physical parameters are constructed. The model is composed of four parts: a geometric processing branch, an electrical processing branch, a material processing branch, and a coupling module, so that accurate capturing of key features of the electric field is ensured.

It should be noted that the input first global geometric feature performs spatial grid division on the device structure through a first feature extractor and extracts a local geometric feature of each grid unit. Subsequently, feature extraction is further performed on these local geometric features to obtain corresponding geometric parameter features. The geometric parameter feature of each grid unit is encoded into a high-dimensional feature vector corresponding to each grid unit through an embedding layer, while the characteristics of a key region are also enhanced, such as the expression capability of device boundaries or a transition region.

The first global electrical feature adopts a multi-resolution convolutional network to extract a global electric field trend and a local variation feature and processes features of different resolutions through an embedding layer to obtain electrical embedding features corresponding to different resolutions, which together constitute a second global electrical feature. A third feature extractor extracts material characteristics through convolutional layers, while adopting an attention mechanism to dynamically allocate weights of material characteristics in different regions, thereby adapting to the diversity of geometric and electrical characteristics. Next, a fuser adopts a joint attention mechanism and outputs a comprehensive high-dimensional feature tensor and effectively captures nonlinear dependency relationships and interaction among the three by evaluating the degree of mutual influence of the geometric structure parameters, the electrical parameters, and the material properties in different regions.

In A4, an encoding module of the solving system configured to dynamically aggregate input feature information and add position information to input data is constructed, so that features in different input structures are better expressed. This module is composed of 5 layers of attention modules.

During the training process, the attention modules of the first two layers complete efficient pruning and sparse processing according to the element size of their internal attention map matrices, set elements smaller than a set threshold (set to 0.1 in this embodiment) in a copy matrix of the attention map matrix to 0, sort the columns of the attention map matrix in a descending order according to the cumulative values by column, set the non-zero elements in the current copy matrix to 1 to obtain a binary mask matrix, save the obtained mask matrix, and record the mapping relationship between the original column number and the sorted column number of each column in the copy matrix.

During the inference process of solving the partial differential equation, each attention module of the first two layers performs static pruning on the attention map matrix in the following manner. After each column of the attention map matrix is sorted based on the corresponding mapping relationship obtained in the training phase, dot multiplication with the corresponding mask matrix obtained in the training phase is performed to complete static pruning of the attention map matrix. In this way, the computational load is significantly reduced, facilitating the computing device to balance the workload.

It should be noted that in order to ensure the solving accuracy of the partial differential equation, this embodiment dynamically selects the attention map matrices in the attention modules that need to undergo static pruning and sparsification, while the remaining attention map matrices adopt a dynamic pruning and sparsification scheme. In this embodiment, the first two layers are selected to use static pruning, and the last three layers adopt dynamic pruning. The dynamic pruning and sparsification scheme refers to comparing the attention map with a set threshold (set to 0.1 in this embodiment) during the inference and training processes. If the value is less than this threshold, it will be directly cleared. The columns of the attention map matrix are then sorted in a descending order according to the cumulative values by column, and the rearranged attention map and the corresponding column number labels are then output to the next layer. This scheme effectively preserves the key feature information of the input data without affecting the accuracy of the solving results.

In A5, a decoding module of the solving system configured to map the features output by the encoding module to the required target output space is constructed. In this embodiment, the decoding module includes a feedforward neural network composed of two fully-connected network layers and a KAN model. In the feedforward neural network, the output of the first fully-connected network layer has the characteristic of neuron sparsity, that is, some neurons are not activated. Therefore, a cascaded neuron pruning and sparsification operation that skips inactivated neurons may be adopted. The cascaded neuron pruning and sparsification operation includes the following. Inactivated neurons are determined according to the output of the first layer during the training process, and their labels are recorded. During the inference process, according to the neuron labels obtained from the training process, all forward computation related to this series of neurons in the first layer and the second layer are skipped, so that the number of times of computation is significantly reduced.

It should be noted that the use of the KAN model is dynamically selected. In order to match the non-smooth solutions or complex-shaped solutions in this embodiment, the KAN model is adopted herein, so that the solving efficiency and result accuracy are significantly improved through efficient feature processing and precise function matching.

In A6, under the same initial data conditions as the training sample set, the same geometric parameter, electrical parameter, and material property are set, a three-dimensional problem domain is constructed, and uniformly-distributed random sampling is performed as input data to form a test data group.

In A7, the test data group obtained in step A6 is used as input data. The same three-dimensional Poisson equation same as the training set is solved using the finite difference method, so as to obtain solving result data and act as a verification data group.

In A8, the test data group obtained in step A6 is used as the input data and is input into the trained solving system. The inference process is completed, and the corresponding solving result data is obtained to act as a data group to be evaluated.

In A9, a fitting error between the data group to be evaluated obtained by the solving system in step A8 and the verification data group obtained by the finite difference method in step A7 is calculated. Whether the solving result of the obtained solving system meets the expected predetermined accuracy requirements is determined. By calculating the solving time of this solving system, whether the speed of solving the partial differential equations meets the standard is evaluated.

In this embodiment, if all indicators of the solving system meet the requirements, the training is stopped and the solving system is output; otherwise, returning to step A2, and the network is adjusted and optimized by modifying the number of training iterations, the number of convolution kernels of the feature extraction unit, the number of neural network layers of the fusion module, and the predetermined threshold of the decoding module. In this way, the prediction results of the solving system are more accurate. When the number of training iterations is excessively large, it may cause overfitting problems resulting in insufficient generalization capability of the acceleration method, and the number of training iterations needs to be reduced. When the number of convolution kernels of the feature extraction unit or the number of network layers of the sampling layer is excessively large, it may cause a large scale of network parameters, and both prediction and training time may be greatly increased, then the number of convolution kernels and network layers may be adjusted and reduced. When the predetermined threshold of decoding is excessively large, it may cause loss of feature information and affect the accuracy of solving results, and the predetermined threshold needs to be appropriately reduced.

In this embodiment, the specific steps for determining whether the obtained solving model meets the accuracy and speed requirements are as follows.

Accuracy evaluation: the solving results implemented using the finite difference method are compared with the solving results obtained through the solving system. The error indicators between them, such as root mean square error (RMSE) or mean absolute error (MAE), etc., are calculated. If the error is within the predetermined accuracy requirement range, the acceleration method is determined to meet the accuracy requirements. In this embodiment, it is preset that the root mean square error between the two groups of solving result data does not exceed 0.5%.

Speed evaluation: the prediction speed of the solving system, i.e., the time required for the solving system to complete prediction under a given input, is calculated. If the prediction speed meets the requirements of practical applications, the solving system is determined to meet the speed requirements. In this embodiment, the maximum solving time is preset not to exceed 20 ms.

Through the evaluation of these requirements, the performance of the solving method in terms of accuracy and speed may be comprehensively understood, so as to determine whether it meets the needs of practical applications. If the requirements are not met, it is necessary to return to step A2 to further adjust and optimize the solving system to improve its performance.

In summary, the disclosure proposes the solving system for the partial differential equations of the electric field of the integrated circuit device, aiming to significantly improve solving efficiency and result accuracy. Based on the geometric parameter, the electrical parameter, and the material property of integrated circuit device, an efficient solving system is constructed and trained by obtaining electric field distribution data under different conditions. The solving system includes multiple key modules. The feature extraction module may independently extract physical parameter features of inputs such as the geometric parameter, the electrical parameter, and the material property. The fusion module combines information from different physical parameters to solve the expression problem of nonlinear complex regions in electric field solving. The encoding module dynamically aggregates global and local information to capture the complex dependency relationships between the electric field coupling effects and the multi-scale features in integrated circuit devices. The decoding module maps the encoding results to target outputs, adapting to non-smooth potential distributions and complex geometric shapes. In addition, optimization means such as the geometry-electrical-material tri-coupling mechanism and the sparse attention mechanism are introduced to further reduce the computational burden and enhance the model's adaptability to multi-scale characteristics. Through this method, not only the solving process of electric field related the partial differential equations in the integrated circuit device is significantly accelerated, but also the adaptability to complex geometric shapes and non-smooth solutions is greatly improved, and the solving accuracy is enhanced. In the integrated circuit device design and performance optimization, this method has extensive application value and may effectively support the rapid development of high-performance and low-power chips.

In the third aspect, the disclosure provides a solving method for partial differential equations of an electric field of an integrated circuit device, and the method includes the following steps.

Physical parameters of the integrated circuit device to be solved into the solving system provided in the first aspect of the disclosure are input to obtain the electric field distribution of the integrated circuit device.

The physical parameters include a geometric parameter, an electrical parameter, and a material property.

The related technical solutions are the same as the solving system provided in the first aspect of the disclosure, so description thereof is not repeated herein.

In the fourth aspect, the disclosure provides an electronic device including a memory and a processor. The memory stores a computer program, and the processor executes the training method of the solving system provided in the second aspect of the disclosure or the solving method provided in the third aspect when executing the computer program.

The related technical solutions are the same as the training method of the solving system provided in the second aspect of the disclosure and the solving method provided in the third aspect, so description thereof is not repeated herein.

In the fifth aspect, the disclosure further provides a computer-readable storage medium. The computer-readable storage medium includes a stored computer program. When the computer program is run by a processor, an apparatus where the storage medium is located is controlled to execute the training method of the solving system provided in the second aspect of the disclosure or the solving method provided in the third aspect.

The related technical solutions are the same as the training method of the solving system provided in the second aspect of the disclosure and the solving method provided in the third aspect, so description thereof is not repeated herein.

In the sixth aspect, the disclosure further provides a computer program product including a computer program/instruction. When the computer program/instruction is executed by a processor, the training method of the solving system provided in the second aspect or the solving method provided in the third aspect is implemented.

The related technical solutions are the same as the training method of the solving system provided in the second aspect of the disclosure and the solving method provided in the third aspect, so description thereof is not repeated herein.

Those skilled in the art may easily understand that the above descriptions are only preferred embodiments of the disclosure and are not intended to limit the disclosure. Any modifications, equivalent substitutions and improvements made within the spirit and principles of the disclosure shall be included within the protection scope of the disclosure.

What is claimed is:

1. A solving system for partial differential equations of an electric field of an integrated circuit device, comprising:
a geometric feature extraction module, configured to extract a feature of a geometric parameter of the integrated circuit device to obtain a first global geometric feature; an electrical feature extraction module, configured to extract a feature of an electrical parameter of the integrated circuit device to obtain a first global electrical feature; and a material feature extraction module, configured to extract a feature of a material property of the integrated circuit device to obtain a first global material feature;
a fusion module, configured to fuse the first global geometric feature, the first global electrical feature, and the first global material feature to obtain a fused feature;
an encoding module, configured to encode the fused feature to obtain an encoded feature; and
a decoding module, configured to decode the encoded feature to obtain electric field distribution of the integrated circuit device,
wherein the fusion module comprises:
a first feature extractor, configured to perform spatial grid division on the first global geometric feature according to an integrated circuit device structure to obtain a local geometric feature of each grid unit, perform feature extraction on each local geometric feature to obtain a geometric parameter feature of each grid unit, and perform embedding processing on the geometric parameter feature of each grid unit to obtain a geometric embedding feature of each grid unit, which together constitute a second global geometric feature;
a second feature extractor, configured to perform feature extraction on the first global electrical feature at multiple scales and perform embedding processing on an obtained feature of each scale to obtain an electrical embedding feature corresponding to each scale, which together constitute a second global electrical feature;
a third feature extractor, comprising a fully-connected layer and configured to input a feature obtained by adding the second global geometric feature and the second global electrical feature into the fully-connected layer for feature extraction and add an extracted feature to the first global material feature to obtain a second global material feature; and
a fuser, configured to treat the second global geometric feature, the second global electrical feature, and the second global material feature as a query matrix, a key matrix, and a value matrix respectively, and perform fusion based on an attention mechanism to obtain the fused feature.

2. The solving system according to claim 1, wherein the encoding module comprises an embedding layer and an encoder,
the embedding layer is configured to perform embedding processing on the fused feature to obtain a fused embedding feature, and
the encoder comprises a cascade of m attention modules configured to process the fused embedding feature based on the attention mechanism to obtain the encoded feature, and m≥2.

3. The solving system according to claim 2, wherein a process of processing an input feature performed by each of the attention modules of the first m₁ attention modules in the encoder based on the attention mechanism further comprises performing static pruning on an attention map matrix after obtaining the attention map matrix, and m₁≥1,
wherein in a training stage of the solving system, the attention module performs the static pruning on the attention map matrix by: copying the attention map matrix to obtain a corresponding copy matrix; summing columns in the copy matrix after setting elements in the copy matrix that are less than a first predetermined threshold to 0, sorting the columns of the copy matrix in a descending order according to a column summation result, and setting non-zero elements in the copy matrix to 1 to obtain a mask matrix; saving the obtained mask matrix and recording a mapping relationship between an original column number and a sorted column number of each of the columns in the copy matrix; and sorting the columns of the attention map matrix based on the mapping relationship and then performing dot multiplication with the mask matrix to complete the static pruning on the attention map matrix,
in a solving stage, the attention module performs the static pruning on the attention map matrix by: after sorting the columns of the attention map matrix based on the corresponding mapping relationship obtained in the training stage, performing the dot multiplication with the corresponding mask matrix obtained in the training stage to complete the static pruning on the attention map matrix.

4. The solving system according to claim 3, wherein a process of processing the input feature performed by each of the attention modules of the last m-m₁ attention modules in the encoder based on the attention mechanism further comprises performing dynamic pruning on the attention map matrix after obtaining the attention map matrix; and
after setting elements in the attention map matrix that are less than a second predetermined threshold to 0, sorting the columns of the attention map matrix in a descending order according to the column summation result to complete the dynamic pruning on the attention map matrix.

5. The solving system according to claim 1, wherein the decoding module comprises a cascade of a feedforward neural network and a decoder, and the feedforward neural network comprises a cascade of multiple fully-connected layers,
an activation function of the fully-connected layers is a ReLU function,
in a solving stage, a first fully-connected layer L in the feedforward neural network is a fully-connected layer with all inactivated neurons removed,
wherein the inactivated neurons are neurons whose outputs are always 0 in the fully-connected layer L counted during a training stage of the solving system.

6. The solving system according to claim 5, wherein the decoder is a KAN model.

7. A training method for the solving system according to claim 1, comprising:
treating training samples in a training set as input and corresponding electric field distribution labels as output to train the solving system,
wherein the training set is obtained by:
collecting real electric field distributions of different integrated circuit devices under different physical parameters, wherein the physical parameters comprising a geometric parameter, an electrical parameter, and a material property; and
constructing the training set with the physical parameters as the training samples and the corresponding real electric field distributions as the electric field distribution labels.

8. A solving method for partial differential equations of an electric field of an integrated circuit device, comprising:
inputting physical parameters of the integrated circuit device to be solved into the solving system according to claim 1, to obtain the electric field distribution of the integrated circuit device,
wherein the physical parameters comprise a geometric parameter, an electrical parameter, and a material property.

9. An electronic device, comprising a memory and a processor, wherein the memory stores a computer program, and the processor executes the method according to claim 7 when executing the computer program.

10. A non-transitory computer-readable storage medium, wherein the computer-readable storage medium comprises a stored computer program, wherein when the computer program is run by a processor, the computer program controls an apparatus where the storage medium is located to execute the method according to claim 7.
